(19) United States
(12) Patent Application Publication
(10) Pub. No.: US 2024/0311200 A1
(43) Pub. Date: Sep. 19, 2024

(54) THREAD DIAPHRAM RESOURCE MODEL (TDRM) FOR REAL-TIME ACCESS CONTROL AND DYNAMIC SIZING OF RESOURCE POOLS

(71) Applicant: INTERNATIONAL BUSINESS MACHINES CORPORATION, Armonk, NY (US)

(72) Inventors: Nadiya KOCHURA, Bolton, MA (US); Fang LU, Billerica, MA (US); Jonathan D. DUNNE, Dungarvan (IE); Mary Diane SWIFT, Rochester, NY (US)

(21) Appl. No.: 18/122,335

(22) Filed: Mar. 16, 2023

(51) Int. Cl. G06F 9/50

(52) U.S. Cl. CPC G06F 9/505; G06F 9/5077

(57) ABSTRACT

Aspects of the present disclosure relate generally to generating a model of resource pool activities for resource pools in a computing environment and, more particularly, to systems, computer program products, and methods of real-time access control and dynamic sizing of resource pools in cloud computing environments. For example, a computer-implemented method includes: analyzing, by a processor set, log events of activities of a resource pool of computing resources; deriving, by the processor set, a model of frequency of resource requests for the resource pool from the activities of the resource pool; generating, by the processor set, an access matrix as output of the model that arbitrates access to resources of the resource pool among new requests for a resource from the resource pool; and arbitrating, by the processor set, the access to the resources of the resource pool among the new requests for a resource from the resource pool.

### BACKGROUND

Aspects of the present invention relate generally to generating a model of resource pool activities for resource pools in a computing environment and, more particularly, to systems, computer program products, and methods of real-time access control and dynamic sizing of resource pools in a cloud computing environment using a model of resource pool activities.

A variety of shared resource pools are defined and configured in cloud computing environments. Web applications, containers and virtual machines can request allocation of resources from shared resource pools required for performing computing tasks. For instance, a web server may define the maximum number of threads in a thread pool which may be allocated to web applications executing on the web server. As another example, a configuration file for a container may define the maximum size of a java heap from which memory may be requested by an executing process thread of the container for allocation to instantiate an object. As a further example, a database server may define a maximum number of connections in a connection pool for web applications to access a database. When the resource pool becomes exhausted for any of these resource pools, requests for allocation of a resource are typically queued until an allocated resource is returned to the resource pool and again becomes available for allocation.

### SUMMARY

In a first aspect of the invention, there is a computer-implemented method including: analyzing, by a processor set, log events of activities of a resource pool of computing resources; deriving, by the processor set, a model of frequency of resource requests for the resource pool from the activities of the resource pool; generating, by the processor set, an access matrix as output of the model that arbitrates access to resources of the resource pool among new requests for a resource from the resource pool; and arbitrating, by the processor set, the access to the resources of the resource pool among the new requests for a resource from the resource pool.

In another aspect of the invention, there is a computer program product including one or more computer readable storage media having program instructions collectively stored on the one or more computer readable storage media. The program instructions are executable to: analyze telemetry data of activities of a resource pool of computing resources; derive a model of frequency of resource requests for the resource pool from the activities of the resource pool; generate a density distribution for the resource pool size as output of the model; and dynamically resize the resource pool based on the density distribution for the resource pool size.

In another aspect of the invention, there is a system including a processor set, one or more computer readable storage media, and program instructions collectively stored on the one or more computer readable storage media. The program instructions are executable to: receive data of arrival times of resource requests and service times of allocated resources for a resource pool of computing resources; model a probability distribution fitting the data of arrival times of resource requests and service times of allocated resources for the resource pool; and output an access matrix from the probability distribution that arbitrates access to resources of the resource pool among new requests for a resource from the resource pool.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 depicts an illustration of an exemplary diagram of data modeling of a resource pool in accordance with aspects of the present invention.

FIG. 4 depicts an illustration of an exemplary diagram of output from a data model of a resource pool in accordance with aspects of the present invention.

FIG. 5 depicts an illustration of an exemplary diagram of access arbitration and dynamic sizing of a resource pool in accordance with aspects of the present invention.

FIG. 6 depicts an illustration of an exemplary diagram of applications in a real-time environment in accordance with aspects of the present invention.

FIG. 7 shows a flowchart of an exemplary method in accordance with aspects of the present invention.

FIG. 8 shows a flowchart of an exemplary method in accordance with aspects of the present invention.

FIG. 9 shows a flowchart of an exemplary method in accordance with aspects of the present invention.

### DETAILED DESCRIPTION

Aspects of the present invention relate generally to generating a model of resource pool activities for resource pools in a computing environment and, more particularly, to systems, computer program products, and methods of real-time access control and dynamic sizing of resource pools in a cloud computing environment. More specifically, aspects of the present invention relate to methods, computer program products, and systems for analyzing log events and telemetry data of activities of a resource pool of computing resources, deriving a model of the frequency of resource requests for the resource pool and the service times of allocated resources from the activities of the resource pool, and outputting an access matrix from the model that arbitrates access to resources of the resource pool among new requests for a resource from the resource pool as well as outputting a density distribution for the resource pool size from the model that is used to dynamically resize the resource pool to its temporal optimal size. Applications competing to consume a static resource pool can grow to a level that exhausts the static pool of resources. According to aspects of the present invention, the methods, systems, and computer program products described herein automatically allocate access to resources as needed on demand and avoid allocation and subsequent return of unused resources. Furthermore, the methods, systems, and computer program products described herein dynamically ensure that resource pools meet application demand.

In embodiments, the methods, systems, and computer program products described herein analyze log events and telemetry data of activities of a resource pool of computing resources. These events and telemetry data of resource pool activities may include in embodiments, for instance, receiving a request for allocation of a resource from the resource pool, allocating a resource from the resource pool, CPU usage of a thread, memory usage of a thread, and other resource usage information and state information from applications, programs or containers running in the computing environment. The methods, systems, and computer program products of the present disclosure model a probability distribution fitting the data of arrival times of resource requests and service times of allocated resources from resource pool activities. As output of the model, the methods, systems, and computer program products of embodiments of the present invention generate an access matrix in embodiments that arbitrates access to resources of the resource pool and a density distribution for the resource pool size to dynamically resize the resource pool to its temporal optimal size.

Aspects of the present invention are directed to improvements in computer-related technology and change the way computers operate in access control and dynamic resizing of computing resource pools, among other features as described herein. In embodiments, the methods, computer program products, and systems may analyze log events and telemetry data of activities of a computing resource pool, derive a model of the frequency of resource requests for the computing resource pool and the service times of allocated resources from the activities of the computing resource pool, output an access matrix from the model that arbitrates access to resources of the computing resource pool, and output a density distribution for the computing resource pool size from the model that is used to dynamically resize the resource pool to its temporal optimal size. Advantageously, the methods, computer program products, and systems described herein automatically allocate access to resources as needed on demand and avoid allocation and subsequent return of unused resources. Furthermore, the methods, systems, and computer program products described herein dynamically ensure that resource pools meet application demand. These are specific improvements in the way computers may operate and interoperate for access control and dynamic resizing of computing resource pools.

Implementations of the disclosure describe additional elements that are specific improvements in the way computers may operate and these additional elements provide non-abstract improvements to computer functionality and capabilities. As an example, the methods, computer program products, and systems describe thread diaphragm resource model (TDRM) build module, log analysis module, resource pool telemetry module, distribution fitting module, distribution goodness of fit module, dependency testing module, TDRM module, thread diaphragm resource model, access matrix and pool size density distribution that analyze log events and telemetry data of activities of a computing resource pool, derive a model of the frequency of resource requests for the computing resource pool and the service times of allocated resources from the activities of the computing resource pool, output an access matrix from the model that arbitrates access to resources of the computing resource pool, and output a density distribution for the computing resource pool size from the model that is used to dynamically resize the resource pool to its temporal optimal size. The additional elements of the methods, computer program products, and systems of the present disclosure are specific improvements in the way computers may operate to automatically allocate access to computing resources as needed on demand and dynamically resize computing resource pools to meet application demand.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as real-time access control and dynamic sizing of resource pools code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

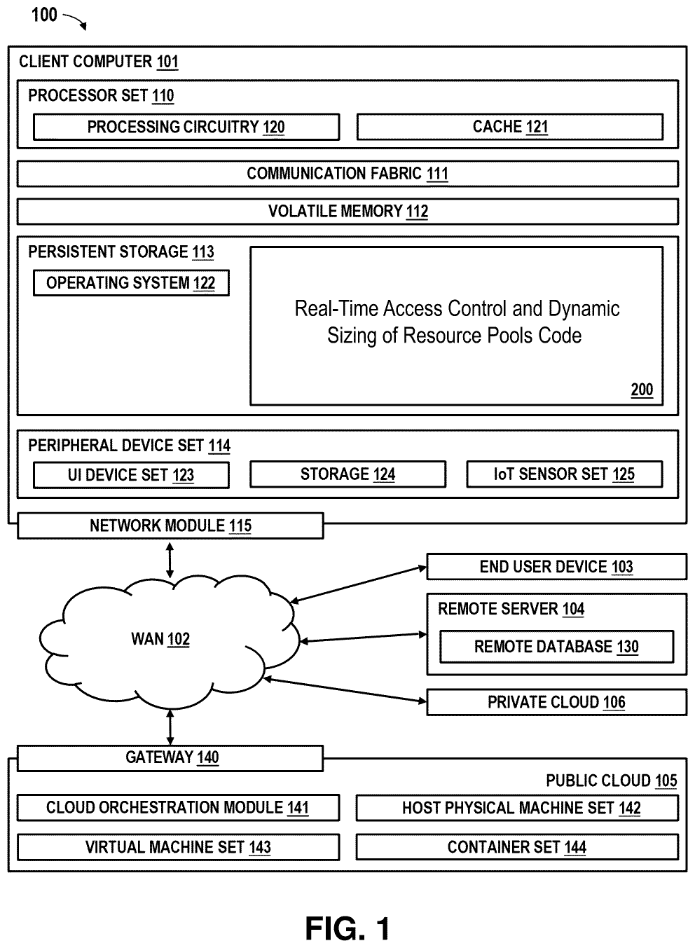

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

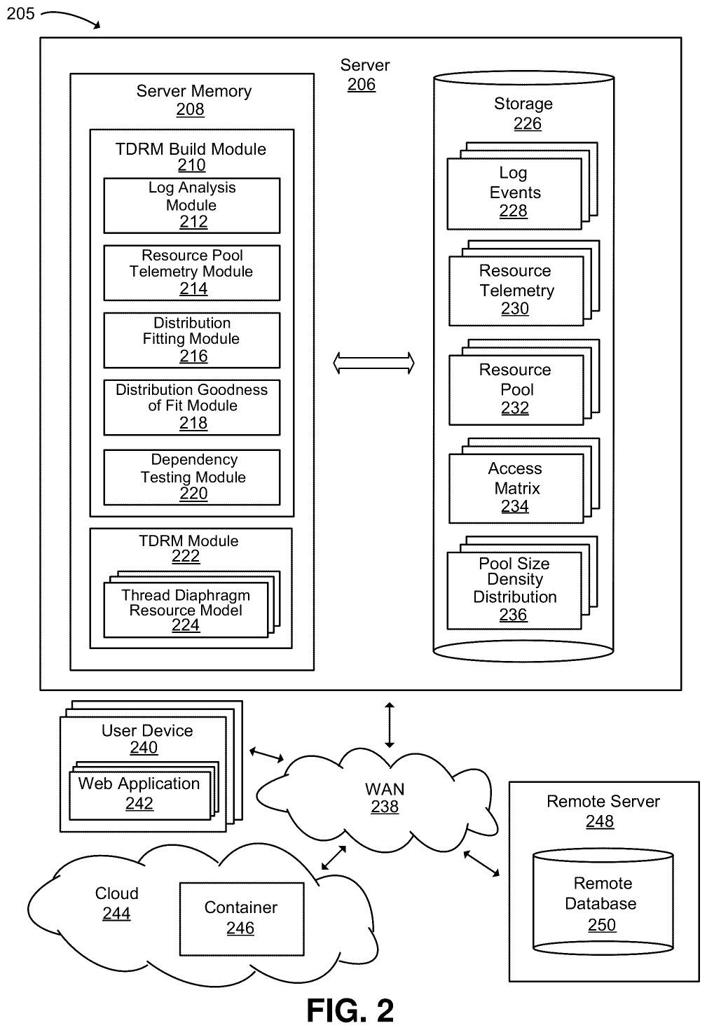

FIG. 2 shows a block diagram of an exemplary environment 205 in accordance with aspects of the present invention. In embodiments, the environment includes a server 206, which may be a computer system such as a computer 101 described with respect to FIG. 1 with which remote servers 104 and public cloud 105, each also described with respect to FIG. 1, may communicate over a network such as WAN 102 described with respect to FIG. 1. In general, server 206 supports services for real-time access control and dynamic sizing of resource pools in a cloud computing environment using a model of resource pool activities.

Server 206 has a server memory 208 such as volatile memory 112 described with respect to FIG. 1. Server 206 includes, in memory 208, TDRM build module 210 having functionality to receive and analyze log event data of resource pool activities, receive and analyze telemetry data of resource pool activities, derive a model of resource pool activities such as thread diaphragm resource model 224, and save the model of resource pool activities in persistent storage, among other functionality in embodiments. The TDRM build module 210 may include in embodiments log analysis module 212 having functionality to scan log events of resource pool activities in system logs, extract log events of resource pool activities from the system logs and store the log events of resource pool activities in persistent storage. Such log events of resource pool activities may include, for example, receiving a request for allocation of a resource from the resource pool, allocating a resource from the resource pool, generating a notification of resource pool exhaustion, queuing a request for a resource from the resource pool in a wait list, and so forth. The TDRM build module 210 may also include in embodiments resource pool telemetry module 214 having functionality to receive telemetry data of resource pool activities exported by telemetry collectors and store the telemetry data of resource pool activities in persistent storage. Such telemetry data of resource pool activities may include, for example, CPU usage of a thread, memory usage of a thread, and other resource usage information and state information from programs or containers running on a system. Such telemetry data of resource pool activities for a database server may include, for example, a count of active connections to the database, a count of failed connections to the database, and other resource usage information and state information of the database server.

The TDRM build module 210 may additionally include in embodiments a distribution fitting module 216, a distribution goodness of fit module 218, and dependency testing module 220 that derive a model of resource pool activities such as thread diaphragm resource model 224 from log events and resource pool telemetry data. In general, the distribution fitting module 216 has functionality to model a probability distribution in a certain time period that fits the log event data and telemetry data of resource activities for a resource pool. In particular, the distribution fitting module 216 models in embodiments the log event data and telemetry data indicative of arrival times of resource request and the length of time the resource is used in probability density distributions of inter-arrival times of resource requests and service times for allocated resources in resource pools. Accordingly, the distribution fitting module 216 models probability density distributions of the frequency of resource requests for a resource pool and the service times of usage of allocated resources for resource pools in a certain time period. The distribution fitting of the data indicative of the arrival times of resource requests and service times for allocated resources in resource pools may be modeled using maximum likelihood estimation in embodiments to generate probability density distributions of inter-arrival times of resource requests and service times for allocated resources in resource pools over a time period. Those skilled in the art should appreciate that the distribution fitting module 216 may use other probability distribution fitting techniques including the method of moments estimation and kernel density estimation (KDE) to name a few.

The distribution goodness of fit module 218 has functionality to assess the goodness of fit of the probability distribution model to the data indicative of the arrival times of resource requests and service times for allocated resources in resource pools. To assess the goodness of fit of the probability distribution model, the distribution goodness of fit module 218 can use the Cramer-von Mises technique, the Kolmogorov-Smirnov technique, the Anderson-Darling technique, or other goodness of fit technique known to those skilled in the art. For some resource pools, the distribution goodness of fit module 218 may determine that the measure of goodness of fit of the probability model derived by the distribution fitting module 216 exceeds a certain threshold and that there is not a sufficient goodness of fit of the model to the data. This may occur, for example, where the inter-arrival times of resource requests for the resource pool are more consistent with a heavy-tailed probability distribution. In this case, a non-parametric technique such as KDE may be used to model and generate a probability density distribution of inter-arrival times of resource requests. For instance, inter-arrival times of connection requests to a database of a database server may, for example, be consistent with a heavy-tailed probability distribution. Accordingly, the distribution fitting module 216 may model the inter-arrival times of connection requests to a database using the KDE technique and generate a probability density distribution that the distribution goodness of fit module 218 determines is a sufficient goodness of fit of the model to the data. In embodiments, the distribution goodness of fit module 218 determines that there is a sufficient goodness of fit of the model to the data if the measure of goodness of fit of the model does not exceed a certain threshold.

Dependency testing module 220 has functionality to perform dependency testing of samples from the data indicative of the arrival times of resource requests and service times to verify that the samples are independent and can be used by the maximum likelihood estimation technique to estimate the parameters of the model.

Continuing with the modules of server 206, server 206 further includes, in memory 208, TDRM module 222 having functionality to arbitrate access to a resource pool via an access matrix and dynamically determine the resource pool size using pool size density distribution output by thread diaphragm resource model 224. TDRM module 222 may include thread diaphragm resource model 224 built by TDRM build module 210 for a resource pool. The thread diaphragm resource model 224 provides an access matrix of probability values used to arbitrate access to a resource pool and provides a pool size density distribution used to dynamically determine the resource pool size.

In embodiments, the server 206 of FIG. 2 comprises TDRM build module 210, log analysis module 212, resource pool telemetry module 214, distribution fitting module 216, distribution goodness of fit module 218, dependency testing module 220, and TDRM module 222, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The server 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, server 206 of FIG. 2 also includes block diagram of storage 226 which may be storage such as storage 124 of computer 101 described with respect to FIG. 1. Storage 226 may store in files log events 228 extracted from system logs for resource pool activities by log analysis module 212. For example, the log events may include receiving a request for allocation of a resource from the resource pool, allocating a resource from the resource pool, generating a notification of resource pool exhaustion, queuing a request for a resource from the resource pool in a wait list, and so forth. Storage 226 may also store in files resource telemetry 230 exported by telemetry collectors and received by resource pool telemetry module 214. For instance, the resource telemetry may include, for example, data of resource pool activities such as CPU usage of a thread, memory usage of a thread, and other resource usage information and state information from programs or containers running on the system. For a database server, such telemetry data of resource pool activities may include, for example, a count of active connections to the database, a count of failed connections to the database, and other resource usage information and state information of the database server.

Storage 226 may additionally store resource pool information 232 in files that may include, for example, identification information, configuration information, and thread diaphragm resource model information, among other information. For instance, the identification information may include an identifier of the resource pool and identifiers of systems that use the resource pool. The configuration information may include the identification of configuration files such as HCL, JSON or YAML file formats with functional and/or procedural instructions to provision the configuration of infrastructure components in a runtime environment of the resource pool. The thread diaphragm resource model information may include an identifier of the thread diaphragm resource model 224 arbitrating access to the resource pool and dynamically determining the resource pool size, an identifier of the access matrix file 234, and an identifier of the pool size density distribution file 236.

Storage 226 may additionally store access matrix files 234 and pool size density distribution files 236 that are each output by one or more thread diaphragm resource models 224. The thread diaphragm resource model 224 provides an access matrix of probability values used to arbitrate access to a resource pool which is stored in access matrix file 234. The thread diaphragm resource model 224 also provides a pool size density distribution used to dynamically determine the resource pool size which is stored in pool size density distribution file 236. There may be in embodiments different thread diaphragm resource models 224 that output different access matrices of probability values used to arbitrate access to different resource pools and output different pool size density distributions used to dynamically determine the sizes of different resource pools. In alternative embodiments, a single thread diaphragm resource model 224 may output a single access matrices of probability values used to arbitrate access to different resource pools and output a single pool size density distribution used to dynamically determine the size of different resource pools.

In accordance with aspects of the present invention, environment 205 of FIG. 2 also shows user device 240 which may be a computer system such as end user device 103, described with respect to FIG. 1, that may communicate over WAN 238 which may be a wide area network such as WAN 102, described with respect to FIG. 1. User device 240 may include web application 242 that may be any type of web application including social media applications, document translation applications, real-time collaborations applications, to name a few. Such web applications may communicate for instance with a web server in a cloud computing environment that requires allocation of resources from a resource pool including threads in a thread pool for executing hypertext transfer protocol (http) requests on the web server received from the web application. The thread diaphragm resource model 224 is used in embodiments to arbitrate access to the resource pool and dynamically determine the resource pool size.

Environment 205 of FIG. 2 further shows cloud 244 which may be a public cloud such as public cloud 105, described with respect to FIG. 1, and container 246 which may be a container such as a container from container set 144, described with respect to FIG. 1. Container 246 may communicate with server 206 and user device 240 from cloud 244 through WAN 138. Web application 242 executing on user device 240 may send an http service request to container 246. Container 246 may require allocation of resources from a resource pool including memory allocated from a java heap, for example, to instantiate objects for execution of the service request. The thread diaphragm resource model 224 is used in embodiments to arbitrate access to the resource pool and dynamically determine the resource pool size.

Environment 205 of FIG. 2 additionally shows remote server 248 that includes remote database 250. Remote server 248 may be a remote server such as remote server 104, described with respect to FIG. 1, and remote database 250 may be a remote database such as remote database 130, described with respect to FIG. 1. Remote server 248 may communicate with server 206 and user device 240 through WAN 138. Web application 242 executing on user device 240 may send an http connection request to remote server 248 to establish a connection to remote database 250. Remote server 248 may require allocation of resources from a resource pool including a connection, for example, from a connection pool to remote database 250 for execution of the http connection request. The thread diaphragm resource model 224 is used in embodiments to arbitrate access to the connection pool and dynamically determine the connection pool size.

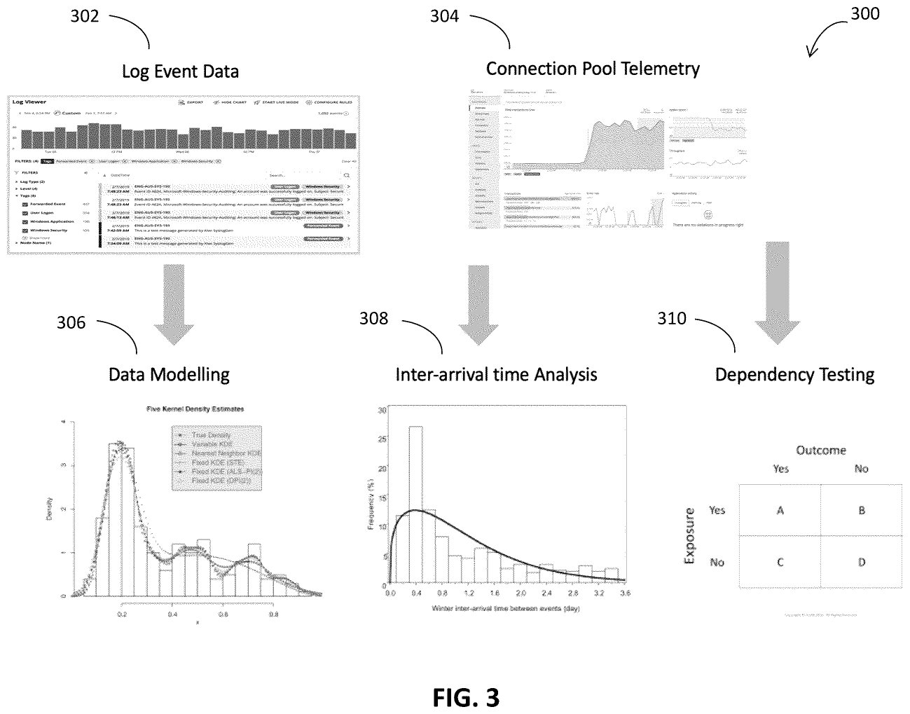

FIG. 3 depicts an illustration of an exemplary diagram of data modeling of a resource pool in accordance with aspects of the present invention. In particular, diagram 300 of FIG. 3 illustrates processing log event data 302 and connection pool telemetry 304 in embodiments to perform data modeling 306 of a connection pool used, for instance, by web applications such as web application 242, described with respect to FIG. 2, to access a database such as remote database 250, described with respect to FIG. 2. The data modeling 306 performs distribution fitting in embodiments that fits the log event data and telemetry data of resource activities for a resource pool to a probability distribution. Diagram 300 of FIG. 3 further illustrates performing inter-arrival time analysis 308 of connection pool requests, for example, from a web application for connection to a database.

In embodiments, the data modeling 306 performs distribution fitting of the log event data and connection pool telemetry data indicative of arrival times of resource request and the length of time the resource is used in probability density distributions of inter-arrival times of resource requests and service times for allocated resources in resource pools. As shown in data modeling 306, the inter-arrival times of connection requests for a connection to a database of a database server from the connection pool are consistent with a heavy-tailed probability distribution. In this case, a non-parametric technique such as KDE may be used to model and generate a probability density distribution of inter-arrival times of connection requests for connection from the connection pool. Accordingly, the distribution fitting may model the inter-arrival times of connection requests to a database using the KDE technique as shown in data modeling 306 of FIG. 3.

Diagram 300 of FIG. 3 further illustrates performing dependency testing 310 of samples from the log event data 302 and connection pool telemetry 304 indicative of the arrival times of connection requests. In embodiments, Fischer's exact test is used to perform dependency testing of samples from the data indicative of the arrival times of resource requests to verify that the samples are independent and can be used by the data modeling technique to estimate the parameters of the model. Those skilled in the art should appreciate that other tests may be used to perform such dependency testing when there are a sufficient number of examples, for instance if the number of expected cell counts in a contingency table using Fischer's exact test are greater than or equal to five (5), including, for example, Barnard's test and Chi-squared test, among other dependency tests. In this way, aspects of the present invention may perform data modeling of a resource pool such as a connection pool.

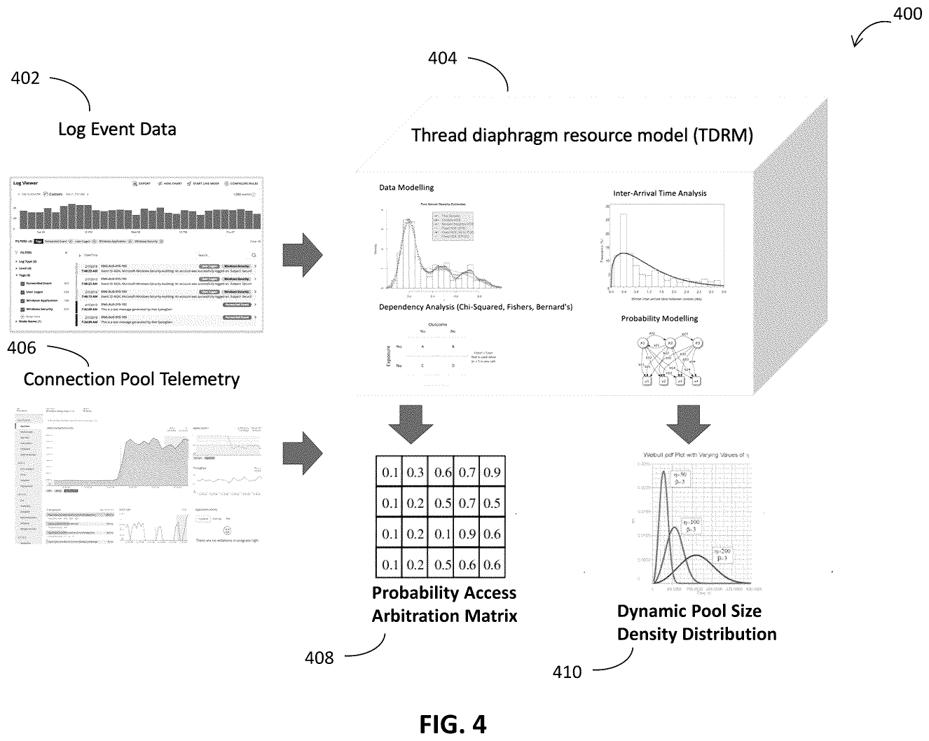

FIG. 4 depicts an illustration of an exemplary diagram of output from a data model of a resource pool in accordance with aspects of the present invention. More specifically, diagram 400 of FIG. 4 illustrates processing log event data 402 and connection pool telemetry 406 in embodiments used to derive a thread diaphragm resource model (TDRM) 404 that outputs a probability access arbitration matrix 408 and a dynamic pool size density distribution 410. For the example of a resource pool that is a connection pool, TDRM 404 is derived from performing inter-arrival time analysis, such as inter-arrival time analysis 308 of connection pool requests, described with respect to FIG. 3, for example, from web applications for connection to a database, and data modeling, such as data modeling 306 of connection pool requests, including distribution fitting and goodness of fit analysis of probability density distributions of inter-arrival times of connection pool requests and service times for allocated connections from the connection pool. Dependency testing such as dependency testing 310, described with respect to FIG. 3, of samples from the log event data 402 and connection pool telemetry 406 indicative of the arrival times of connection requests is also performed in deriving TRDM 404 to verify that the samples are independent and can be used by the data modeling technique to estimate the parameters of the model.

Probability access arbitration matrix 408 output by TDRM 404 is a probability matrix of values between 0 and 1 that represent the probability a thread will continue to execute and likely keep allocated resources or request additional resources from the resource pool. The probability access arbitration matrix 408 output by TDRM 404 can be used in a real-time execution environment to remove threads that become idle from resource access as well as arbitrate whether long running threads should gain access to the pool at a given point in time or be set to sleep for a specified time period. Dynamic pool size density distribution 410 output by TDRM 404 can be used in a real-time execution environment to dynamically expand and contract the size of the resource pool. By modeling prior data of the arrival times of connection requests, the temporal optimal size of a connection pool can be determined. In this way, aspects of the present invention may arbitrate access to a resource pool and dynamically expand and contract the size of the resource pool based on the pool's temporal optimal size.

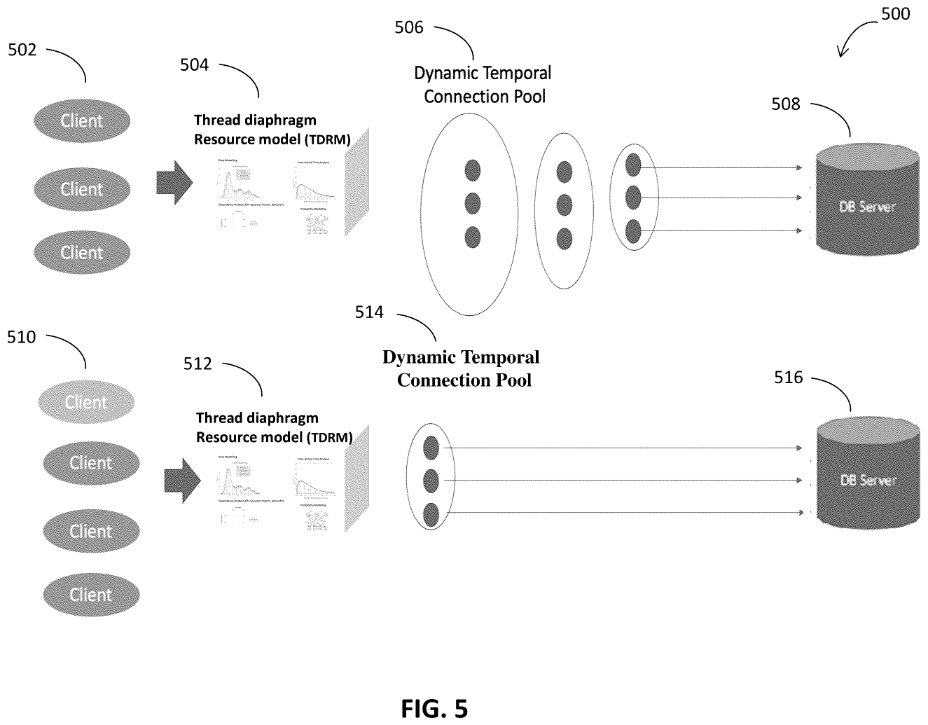

FIG. 5 depicts an illustration of an exemplary diagram of access arbitration and dynamic sizing of a resource pool in accordance with aspects of the present invention. In particular, diagram 500 of FIG. 5 illustrates three web application clients 502 with connections to database server 508 allocated from dynamic temporal connection pool 506 whose size is determined dynamically by thread diaphragm resource model (TDRM) 504. The visualization of the dynamic temporal connection pool 506 illustrated in FIG. 5 shows the dynamic temporal connection pool 506 is contracting. In embodiments, a pool size density distribution, such as dynamic pool size density distribution 410 described with respect to FIG. 4, may be output by TDRM 504 that expands and contracts the size of a resource pool based on the pool's temporal optimal size.

Diagram 500 of FIG. 5 also illustrates four web application clients 510 with access arbitrated by thread diaphragm resource model (TDRM) 512 to dynamic temporal connection pool 514 of connections to database server 516. The visualization of the dynamic temporal connection pool 506 illustrated in FIG. 5 shows three connections in the dynamic temporal connection pool 506 allocated to three of the four web application clients 510. For example, the unconnected web application client can be idle and have its access removed from the dynamic temporal connection pool 506 by TDRM 512. As another example, the unconnected web application client can be a long running process that is set to sleep for a specified time period to allow other processes access for allocation of connections to execute data base transactions. In embodiments, an access matrix such as probability access arbitration matrix 408 described with respect to FIG. 4, may be output by TDRM 504 that removes threads that become idle from resource access and arbitrates whether long running threads should gain access to the pool at a given point in time or be set to sleep for a specified time period.

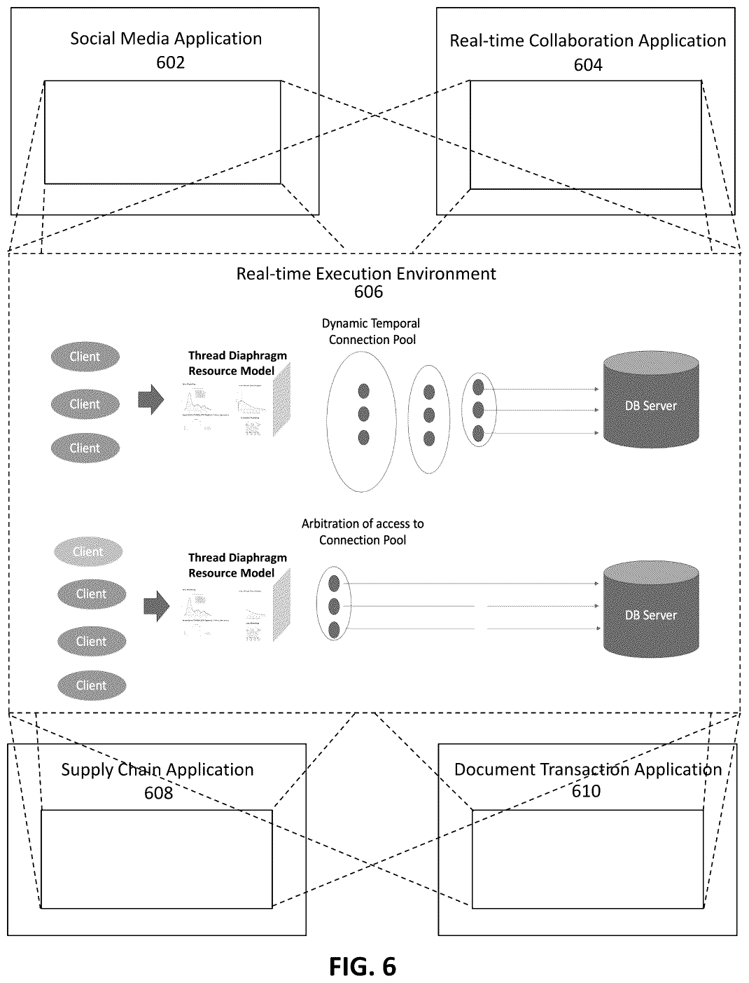

FIG. 6 depicts an illustration of an exemplary diagram of applications in a real-time environment in accordance with aspects of the present invention. More specifically, diagram 600 of FIG. 6 illustrates four web application that generally may be configured with the thread diaphragm resource model in a real-time environment to arbitrate access to a resource pool and dynamically expand and contract the size of the resource pool based on the pool's temporal optimal size. For example, each of social media application 602, real-time collaboration application 604, supply chain application 608, and document translation application 610 may be configured with connections from a connection pool to a database server and with the thread diaphragm resource model in a real-time environment that arbitrates access to the connection pool and dynamically determines the size of the connection pool such as real-time execution environment 606 illustrated in FIG. 6. In embodiments, each of these web applications may be a web application such as web application 242 operating in exemplary environment 205 with connections to remote server 248 and in communication with server 206 and TDRM module 222, each described with respect to FIG. 2.

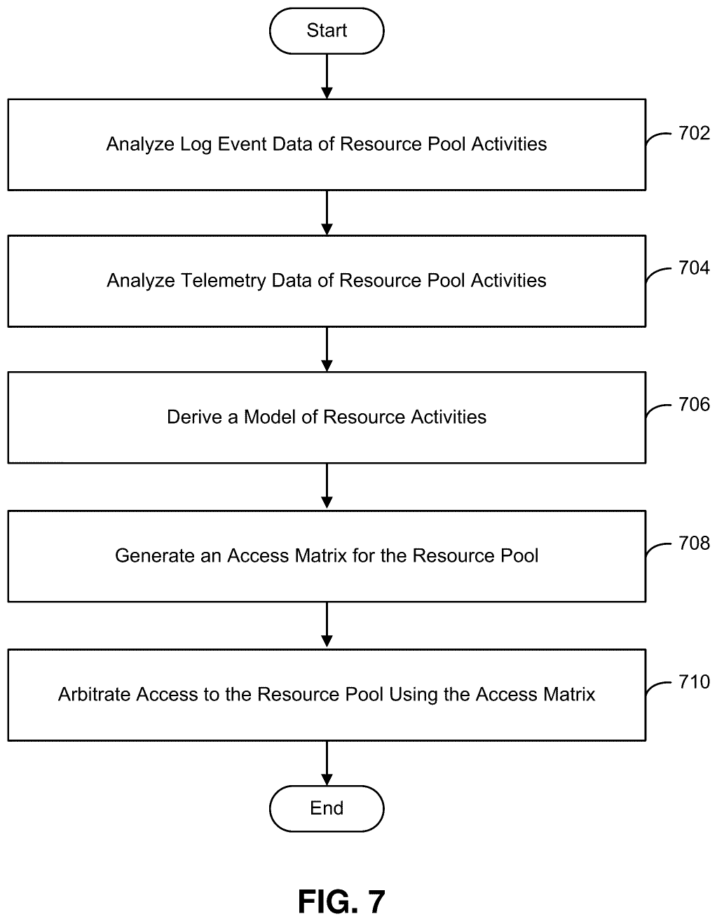

FIGS. 7-9 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 7 shows a flowchart of an exemplary method in accordance with aspects of the present invention. Steps of the method may be carried out in the environment of FIG. 2 and are described with reference to elements depicted in FIG. 2. In particular, the flowchart of FIG. 7 shows an exemplary method for arbitrating access to a resource pool in accordance with aspects of the present invention.

At step 702, the system analyzes log event data of resource pool activities. For example, the system can scan log events of resource pool activities in system logs, extract log events of resource pool activities from the system logs and store the log events of resource pool activities in persistent storage. Such log events of resource pool activities may include, for instance, receiving a request for allocation of a resource from the resource pool, allocating a resource from the resource pool, generating a notification of resource pool exhaustion, queuing a request for a resource from the resource pool in a wait list, and so forth. In embodiments, and as described with respect to FIG. 2, log analysis module 212 analyzes log event data of resource pool activities.

At step 704, the system analyzes telemetry data of resource pool activities. For example, the system can receive telemetry data of resource pool activities exported by telemetry collectors and store the telemetry data of resource pool activities in persistent storage. Such telemetry data of resource pool activities may include, for example, CPU usage of a thread, memory usage of a thread, and other resource usage information and state information from programs or containers running on a system. As another example, telemetry data of resource pool activities for a database server may include a count of active connections to the database, a count of failed connections to the database, and other resource usage information and state information of the database server. In embodiments, and as described with respect to FIG. 2, resource pool telemetry module 214 analyzes telemetry data of resource pool activities.

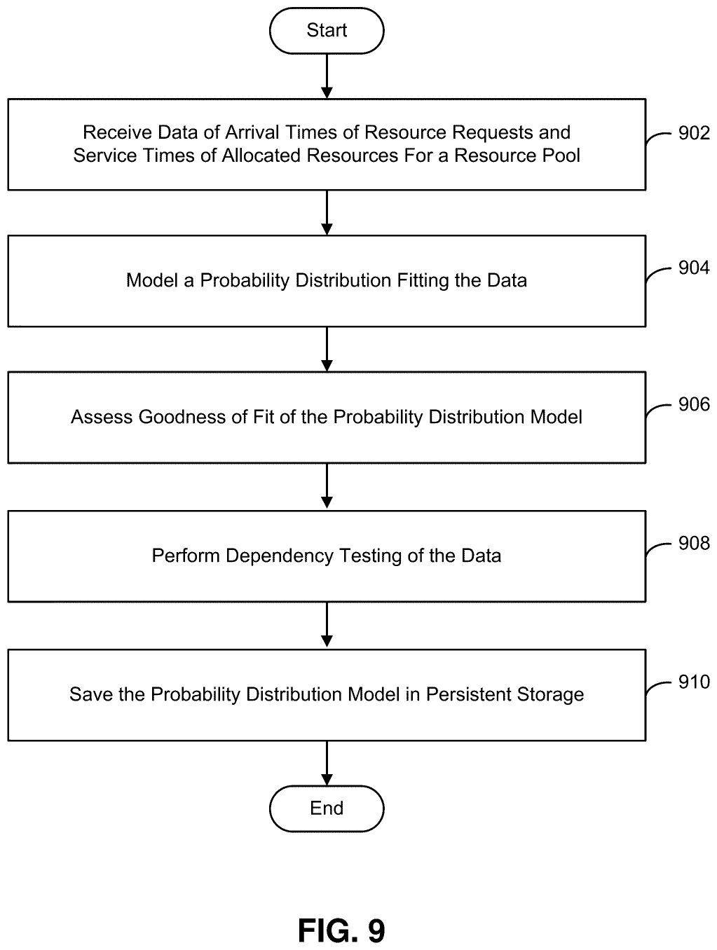

At step 706, the system derives a model of resource activities. For instance, the system can derive a probability distribution model of resource pool activities that fits the log event data and telemetry data of resource activities for a resource pool. In embodiments, the system includes TDRM build module 210, distribution fitting module 216, distribution goodness of fit module 218, and dependency testing module 220, each described with respect to FIG. 2 that derive a model of resource pool activities such as thread diaphragm resource model 224, also described with respect to FIG. 2, from log events and resource pool telemetry data. FIG. 9 below describes in further detail the method for deriving a probability distribution model of resource pool activities in embodiments that fits the log event data and telemetry data of resource activities for a resource pool.

At step 708, the system generates an access matrix for the resource pool. For example, the system provides an access matrix of probability values that may be output by the model of resource activities and used to arbitrate access to a resource pool. The access matrix is a probability matrix of values between 0 and 1 that represent the probability a thread will continue to execute and likely keep allocated resources or request additional resources from the resource pool. In embodiments, and as described with respect to FIG. 2, the thread diaphragm resource model 224 provides an access matrix of probability values used to arbitrate access to a resource pool which is stored in access matrix file 234.

At step 710, the system arbitrates access to the resource pool using the access matrix. For example, the system uses the values in the access matrix that represent the probability a thread will continue to execute and likely keep allocated resources or request additional resources from the resource pool to arbitrate whether long running threads should gain access to the pool at a given point in time or be set to sleep for a specified time period. The system also uses the values in the access matrix to remove threads from resource access that become idle. Thus, the system can allocate access to resources as needed on demand and avoid allocation and subsequent return of unused resources. In embodiments, and as described with respect to FIG. 2, TDRM module 222 arbitrates access to the resource pool using the access matrix.

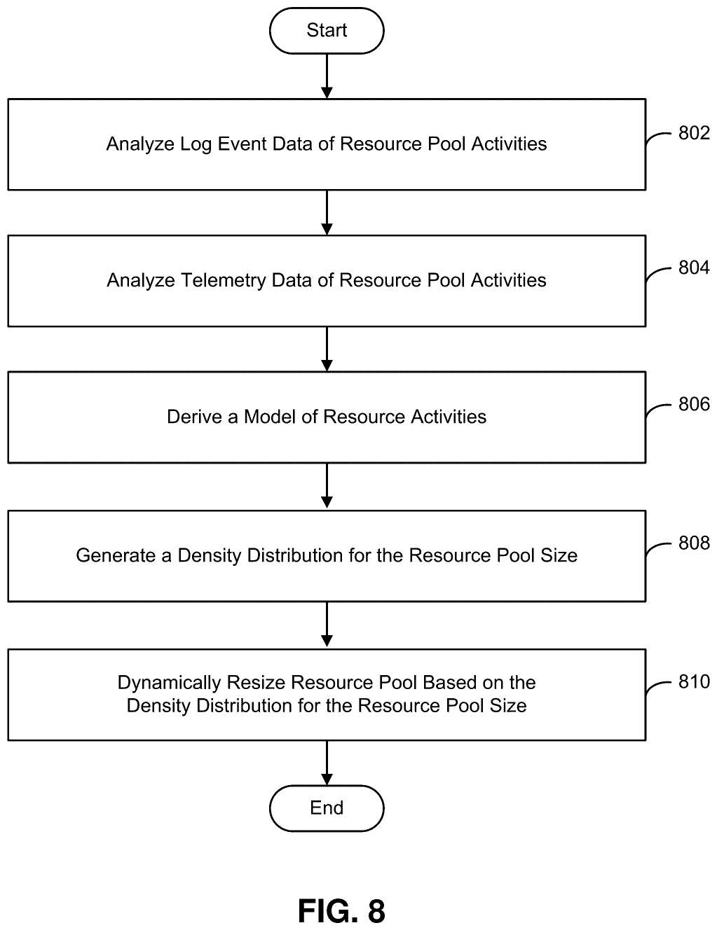

FIG. 8 shows a flowchart of an exemplary method in accordance with aspects of the present invention. Steps of the method may be carried out in the environment of FIG. 2 and are described with reference to elements depicted in FIG. 2. In particular, the flowchart of FIG. 8 shows an exemplary method for dynamically determining the size of a resource pool, in accordance with aspects of the present invention.

At step 802, the system analyzes log event data of resource pool activities. For example, the system can scan log events of resource pool activities in system logs, extract log events of resource pool activities from the system logs and store the log events of resource pool activities in persistent storage. Such log events of resource pool activities may include, for instance, receiving a request for allocation of a resource from the resource pool, allocating a resource from the resource pool, generating a notification of resource pool exhaustion, queuing a request for a resource from the resource pool in a wait list, and so forth. In embodiments, and as described with respect to FIG. 2, log analysis module 212 analyzes log event data of resource pool activities.

At step 804, the system analyzes telemetry data of resource pool activities. For example, the system can receive telemetry data of resource pool activities exported by telemetry collectors and store the telemetry data of resource pool activities in persistent storage. Such telemetry data of resource pool activities may include, for example, CPU usage of a thread, memory usage of a thread, and other resource usage information and state information from programs or containers running on a system. As another example, telemetry data of resource pool activities for a database server may include a count of active connections to the database, a count of failed connections to the database, and other resource usage information and state information of the database server. In embodiments, and as described with respect to FIG. 2, resource pool telemetry module 214 analyzes telemetry data of resource pool activities.

At step 806, the system derives a model of resource activities. For instance, the system can derive a probability distribution model of resource pool activities that fits the log event data and telemetry data of resource activities for a resource pool. In embodiments, the system includes TDRM build module 210, distribution fitting module 216, distribution goodness of fit module 218, and dependency testing module 220, each described with respect to FIG. 2 that derive a model of resource pool activities such as thread diaphragm resource model 224, also described with respect to FIG. 2, from log events and resource pool telemetry data. FIG. 9 below describes in further detail the method for deriving a probability distribution model of resource pool activities in embodiments that fits the log event data and telemetry data of resource activities for a resource pool.

At step 808, the system generates a density distribution for the resource pool size. For example, the system provides a density distribution output by the model of resource activities that indicates the number of resource requests and/or resource allocations by arrival time. By modeling prior data of the arrival times of resource requests, the temporal optimal size of a resource pool can be determined by the density distribution for the resource pool size. In embodiments, and as described with respect to FIG. 2, the thread diaphragm resource model 224 outputs a density distribution for the resource pool size which is stored in pool size density distribution file 236.

At step 810, the system dynamically resizes the resource pool based on the density distribution for the resource pool size. For example, the system may expand and contract the size of a resource pool based on the pool's temporal optimal size reflected by the density distribution for the resource pool size. Thus, the system can dynamically ensure that resource pools meet application demand. In embodiments, and as described with respect to FIG. 2, TDRM module 222 dynamically resizes the resource pool based on the density distribution for the resource pool size.

FIG. 9 shows a flowchart of an exemplary method in accordance with aspects of the present invention. Steps of the method may be carried out in the environment of FIG. 2 and are described with reference to elements depicted in FIG. 2. In particular, the flowchart of FIG. 9 shows an exemplary method for deriving a probability distribution model of resource pool activities, in accordance with aspects of the present invention.

At step 902, the system receives data of arrival times of resource requests and service times of allocated resources for a resource pool. For example, log event data and telemetry data indicative of arrival times of resource request and service times of allocated resources for a resource pool are provided from log events file 228 and resource telemetry file 230. In embodiments, and as described with respect to FIG. 2, distribution fitting module 216 receives data of arrival times of resource requests and service times of allocated resources for a resource pool.

At step 904, the system models a probability distribution that fits the data of arrival times of resource requests and service times of allocated resources for a resource pool. For example, the system models the frequency and distribution of resource requests for resources of a resource pool. In embodiments, the distribution fitting module 216, described with respect to FIG. 2. models the data of arrival times of resource requests and service times of allocated resources for a resource pool in probability density distributions of inter-arrival times of resource requests and service times for allocated resources in resource pools. Accordingly, the distribution fitting module 216 models probability density distributions of the frequency of resource requests for a resource pool and the service times of usage of allocated resources for resource pools in a certain time period. The distribution fitting of the data may be modeled using maximum likelihood estimation in embodiments to generate probability density distributions of inter-arrival times of resource requests and service times for allocated resources in resource pools over a time period. Those skilled in the art should appreciate that the distribution fitting module 216 may use other probability distribution fitting techniques including the method of moments estimation and kernel density estimation (KDE) to name a few.

For some resource pools, the inter-arrival times of resource requests are more consistent with a heavy-tailed probability distribution. In this case, a non-parametric technique such as KDE may be used to model and generate a probability density distribution of inter-arrival times of resource requests. For instance, inter-arrival times of connection requests to a database of a database server may, for example, be consistent with a heavy-tailed probability distribution. Accordingly, the distribution fitting module 216 may model the inter-arrival times of connection requests to a database using the KDE technique and generate a probability density distribution. In embodiments, and as described with respect to FIG. 2, distribution fitting module 216 models a probability distribution that fits the data of arrival times of resource requests and service times of allocated resources for a resource pool.

At step 906, the system assesses goodness of fit of the probability distribution model. For example, the system can assess the goodness of fit of the probability distribution model from a measure of goodness of fit of the model using the Cramer-von Mises technique, the Kolmogorov-Smirnov technique, the Anderson-Darling technique, or other goodness of fit technique known to those skilled in the art. The system can determine that there is a sufficient goodness of fit of the model to the data if the measure of goodness of fit of the model does not exceed a certain threshold. In embodiments, and as described with respect to FIG. 2, distribution goodness of fit module 218 assesses goodness of fit of the probability distribution model.

At step 908, the system performs dependency testing of the data of inter-arrival times of resource requests for the resource pool. For example, the system performs dependency testing of samples from the data of inter-arrival times of resource requests for the resource pool to verify that the samples are statistically independent and can be used, for example, by the maximum likelihood estimation technique to estimate the parameters of the model. In embodiments, Fischer's exact test can be used to perform dependency testing of samples from the data, for instance if the number of expected cell counts in a contingency table using Fischer's exact test are less than five (5). Those skilled in the art should appreciate that other tests may be used to perform such dependency testing when there are a sufficient number of examples, for instance if the number of expected cell counts in a contingency table using Fischer's exact test are greater than or equal to five (5), including, for example, Barnard's test and Chi-squared test, among other dependency tests. In embodiments, and as described with respect to FIG. 2, dependency testing module 220 performs dependency testing of the data of inter-arrival times of resource requests for the resource pool.

At step 910, the system saves the probability distribution model of resource pool activities in persistent storage. For example, the system saves thread diaphragm resource module 224 in persistent storage of server 206, each described with respect to FIG. 2. In embodiments, and as described with respect to FIG. 2, TDRM build module 210 saves the probability distribution model of resource pool activities in persistent storage.

In this way, embodiments of the present disclosure derive a probability distribution model of resource pool activities that fits the log event data and telemetry data of resource activities for a resource pool. Advantageously, embodiments of the present disclosure provide an access matrix used by applications to allocate access to resources as needed on demand and avoid allocation and subsequent return of unused resources. Furthermore, embodiments of the present disclosure provide a density distribution for the resource pool size used to dynamically ensure that resource pools meet application demand.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
analyzing, by a processor set, log events of activities of a resource pool of computing resources;
deriving, by the processor set, a model of frequency of resource requests for the resource pool from the activities of the resource pool;
generating, by the processor set, an access matrix as output of the model that arbitrates access to resources of the resource pool among new requests for a resource from the resource pool; and
arbitrating, by the processor set, the access to the resources of the resource pool among the new requests for a resource from the resource pool using the access matrix.

2. The method of claim 1, further comprising receiving, by the processor set, the log events of activities of the resource pool of computing resources.

3. The method of claim 1, further comprising receiving, by the processor set, telemetry data of activities of the resource pool of computing resources.

4. The method of claim 1, further comprising analyzing, by the processor set, telemetry data of activities of the resource pool of computing resources.

5. The method of claim 1, further comprising:
generating, by the processor set, a density distribution for the resource pool size as output of the model; and
dynamically resizing, by the processor set, the resource pool based on the density distribution for the resource pool size.

6. The method of claim 1, wherein the deriving the model comprises modeling a probability distribution fitting data from the activities of the resource pool of arrival times of the resource requests and service times of allocated resources for the resource pool.

7. The method of claim 1, wherein the deriving the model comprises assessing, by the processor set, goodness of fit of the model.

8. The method of claim 1, wherein the deriving the model comprises performing, by the processor set, dependency testing of samples of data from the activities of the resource pool of arrival times of the resource requests that verifies that the samples are statistically independent.

9. The method of claim 1, wherein the arbitrating the access to the resources of the resource pool comprises removing access of resources of the resource pool from an idle processing thread.

10. The method of claim 1, wherein the arbitrating the access to the resources of the resource pool comprises removing access of resources of the resource pool from a continuously running processing thread.

11. A computer program product comprising one or more computer readable storage media having program instructions collectively stored on the one or more computer readable storage media, the program instructions executable to:
analyze telemetry data of activities of a resource pool of computing resources;
derive a model of frequency of resource requests for the resource pool from the activities of the resource pool;
generate a density distribution for the resource pool size as output of the model; and
dynamically resize the resource pool based on the density distribution for the resource pool size.

12. The computer program product of claim 11, wherein the program instructions are further executable to analyze log events of activities of the resource pool of computing resources.

13. The computer program product of claim 11, wherein the program instructions are further executable to:
generate an access matrix as output of the model that arbitrates access to resources of the resource pool among new requests for a resource from the resource pool; and
arbitrate the access to the resources of the resource pool among the new requests for a resource from the resource pool using the access matrix.

14. The computer program product of claim 11, wherein the deriving the model comprises modeling a probability distribution fitting data from the activities of the resource pool of arrival times of the resource requests and service times of allocated resources for the resource pool.

15. The computer program product of claim 11, wherein the deriving the model comprises assessing goodness of fit of the model.

16. The computer program product of claim 11, wherein the resource pool is dynamically resized to a temporal optimal size of the resource pool determined from the density distribution for the resource pool size.

17. A system comprising:
a processor, a computer readable memory, one or more computer readable storage media, and program instructions collectively stored on the one or more computer readable storage media, the program instructions executable to:
receive data of arrival times of resource requests and service times of allocated resources for a resource pool of computing resources;
model a probability distribution fitting the data of arrival times of resource requests and service times of allocated resources for the resource pool; and
output an access matrix from the probability distribution that arbitrates access to resources of the resource pool among new requests for a resource from the resource pool.

18. The system of claim 17, wherein the program instructions are further executable to output a density distribution for the resource pool size from the probability distribution.

19. The system of claim 17, wherein the program instructions are further executable to assess goodness of fit of the probability distribution modeled.

20. The system of claim 17, wherein the program instructions are further executable to perform dependency testing of samples of the data of arrival times of resource requests for the resource pool that verifies that the samples are statistically independent.
